(19) United States
(12) Patent Application Publication
(10) Pub. No.: US 2017/0036825 A1
(43) Pub. Date: Feb. 9, 2017

(54) AIRTIGHT CONTAINER FOR POSITIVE PRESSURE BEVERAGE AND MANUFACTURING METHOD FOR THE SAME

(71) Applicant: NIPPON CLOSURES CO., LTD., Tokyo (JP)

(72) Inventors: Koji Kitano, Osaka-shi (JP); Haruhiko Kondo, Osaka-shi (JP); Yuko Fukuoka, Osaka-shi (JP); Mitsuo Kumata, Hiratsuka-shi (JP); Katsuhito Ichimura, Hiratsuka-shi (JP); Yusuke Okubo, Hiratsuka-shi (JP)

(73) Assignee: NIPPON CLOSURES CO., LTD., Tokyo (JP)

(21) Appl. No.: 15/304,278

(22) PCT Filed: Apr. 10, 2015
(86) PCT No.: PCT/JP2015/061190

§ 371 Date: Oct. 14, 2016

(30) Foreign Application Priority Data
Apr. 15, 2014 (JP) 2014-083484

(51) Int. Cl. B65D 41/40; B67C 3/22; B67C 7/00; B67B 3/02

(52) U.S. Cl. CPC B65D 41/40; B67B 3/02; B67C 3/22; B67C 7/00

(57) ABSTRACT

Provided is an airtight container for positive pressure beverage that has a cap which is able to improve airtightness. The airtight container for beverage is provided with a beverage container and a cap. The beverage container has a body portion and a flange. The flange is continuous with an upper portion of the body portion and defines an orifice. The cap is attached to the beverage container so as to seal the orifice. The cap has a liner and an exterior body. The liner has a thin liner portion for sealing a lower side portion of the flange and a thick liner portion for sealing an upper side portion of the flange. The exterior body is fixed to the flange so as to cover the liner from an outer side, in order to seal the orifice together with the liner. The exterior body presses the thin liner portion against the lower side portion of the flange and brings the thin liner portion in close contact therewith.

### TECHNICAL FIELD

The present invention relates to an airtight container for positive pressure beverage that is provided with a cap which is able to improve airtightness, and a manufacturing method for the same.

### BACKGROUND ART

Conventionally, there is a well-known beverage container cap called a Maxi Cap (registered trademark) that has a metal exterior body and a liner that is disposed on an inner surface of the exterior body. As shown in Patent Literature 1, the liner of this type of cap is configured so as to closely contact the flange of a mouth portion firmly, in order for an orifice of the beverage container to be reliably sealed by the elasticity of the liner.

### CITATION LIST

### Patent Literature

Patent Literature 1: WO 2007/122971

### SUMMARY OF INVENTION

### Technical Problem

Incidentally, there are cases where beverage containers to which this type of cap is attached contain carbonated beverages, or contain an inert gas together with the beverage for purposes such as antioxidation and improving the strength of the container (hereinafter, gas contained separately to the beverage will also be described as being part of the beverage, unless expressly stated otherwise). Although it is particularly necessary to enhance the airtightness of the container in the case where the beverage contained in the container includes a gas (positive pressure beverage), the liner is often made of a gas-permeable material such as a resin. Thus, with the conventional cap shown in Patent Literature 1, the inventors discovered that gas leaks out from the container along a route such as shown in FIG. 1. That is, although the liner needs to have a certain thickness in order to ensure an elastic force for exhibiting adhesion to the flange of the mouth portion of the beverage container, such a liner provides a way for gas to escape. Having said that, simply making the liner thinner will adversely affect the adhesion to the mouth portion of the beverage container.

An object of the present invention is to provide an airtight container for positive pressure beverage that is provided with a cap which is able to improve airtightness, and to a manufacturing method for the same.

### Solution to Problem

An airtight container for positive pressure beverage according to a first aspect of the present invention is provided with a beverage container and a cap. The beverage container has a body portion and a flange. The flange is continuous with an upper portion of the body portion and defines an orifice. The cap is attached to the beverage container so as to seal the orifice. The cap has a liner and an exterior body. The liner has a thin liner portion for sealing a lower side portion of the flange and a thick liner portion for sealing an upper side portion of the flange. The exterior body is fixed to the flange so as to cover the liner from an outer side, in older to seal the orifice together with the liner. The exterior body presses the thin liner portion against the lower side portion of the flange and brings the thin liner portion in close contact therewith.

The cap described here has a liner and an exterior body. The liner has a thick liner portion, and the thick liner portion covers an upper side portion of a flange that defines an orifice of a beverage container, in order to seal the beverage container. That is, since the liner is able to exhibit sufficient elastic force at the thick liner portion, the liner closely contacts the upper side portion of the flange securely, and the orifice of the beverage container is liquid tightly sealed. Also, the thick liner portion has pressure resistance and shock resistance. Furthermore, here, in addition to the above features, the liner has a thin liner portion. This thin liner portion is pressed against a lower side portion of the flange by the exterior body. That is, since the passage for gas is narrowed at the thin liner portion, gaseous communication between the inside and outside of the beverage container via a resin liner is suppressed. Accordingly, here, the airtightness of the airtight container can be improved.

Also, here, since the airtight container contains a positive pressure beverage that includes a gas such as carbonic acid or an inert gas, an upward force acts on the cap due to the gas trying to escape out of the beverage container. Thus, the exterior body and the thin liner portion are brought in close contact by the lower side portion of the flange, and the airtightness of the airtight container further increases.

An airtight container according to a second aspect of the present invention is the airtight container according to the first aspect, in which a rounded corner region is formed on the lower side portion of the flange.

Here, due to the thin liner portion being brought in close contact with a corner region of the lower side portion of the flange, the liner firmly catches on the flange and is fixed. Furthermore, due to this corner region being rounded, conforming the thin liner portion to the flange is facilitated. As a result, here, the liner is firmly fixed, and consequently the sealing performance of the airtight container can be enhanced.

An airtight container according to a third aspect of the present invention is the airtight container according to the first Of second aspect, in which the exterior body extends further downward than the liner, to an extent that an entirety of the liner is confinable within a space formed between the exterior body and the beverage container.

Here, due to the exterior body extending further downward than the liner, the exterior body catches firmly on the flange and is fixed. Also, due to the entire thin liner portion being confined between the exterior body and the beverage container, gas communication via the thin liner portion is further suppressed, and the sealing performance of the airtight container can be enhanced.

An airtight container according to a fourth aspect of the present invention is the airtight container according to any of the first to third aspects, in which the liner is made of a resin. That is, the liner closely contacts the flange of the mouth portion firmly, in order for the orifice of the beverage container to be reliably liquid tightly sealed by the elasticity of the liner.

An airtight container according to a fifth aspect of the present invention is the airtight container according to any of the first to fourth aspects, in which the exterior body is made of a plastically deformable metal. That is, the liner can be readily fixed to the beverage container by the exterior body.

An airtight container manufacturing method according to a sixth aspect of the present invention is a method for manufacturing an airtight container for positive pressure beverage, the method including a step of preparing a beverage container, a step of preparing a cap, a step of filling the beverage container with a positive pressure beverage, and a step of fixing the cap to the beverage container, after the beverage container has been filled with the positive pressure beverage. The beverage container has a body portion and a flange that is continuous with an upper portion of the body portion and defines an orifice. The cap has a liner and an exterior body. The liner has a thin liner portion for sealing a lower side portion of the flange and a thick liner portion for sealing an upper side portion of the flange. The exterior body is to be fixed to the flange so as to cover the liner from an outer side, in order to seal the orifice together with the liner. Also, in the step of fixing the cap to the beverage container, the thin hirer portion is pressed against the lower side portion of the flange and brought in dose contact therewith. With an airtight container that is manufactured by this method, similar effects to the first aspect can be achieved.

### Advantageous Effects of Invention

According to the present invention, since the liner is able to exhibit sufficient elastic force at the thick liner portion, the thick liner portion closely contacts the upper side portion of the flange securely, and the orifice of the beverage container is liquid tightly sealed. Also, the thick liner portion has pressure resistance and shock resistance. Furthermore, the liner is pressed against the lower side portion of the flange by the exterior body at the thin liner portion. That is, since the gas passage is narrowed at the thin liner portion, gas communication between the inside and outside of the beverage container via the liner can be suppressed. Accordingly, here, the airtightness of the airtight container can be improved.

### BRIEF DESCRIPTION OF DRAWINGS

FIG. 1 is a cross-sectional view of a conventional capping mechanism that results in gas leakage.

FIG. 2 is an external perspective view of an airtight container according to one embodiment of the present invention.

FIG. 3 is an external perspective view of a cap according to one embodiment of the present invention.

FIG. 4 is a side cross-sectional view of the cap.

FIG. 5 is a partial side cross-sectional view of the cap and a beverage container before capping.

FIG. 6 is partial enlarged view of the vicinity of the flange in FIG. 5.

FIG. 7 is a diagram illustrating a process of capping the airtight container according to one embodiment of the present invention.

FIG. 8 is a partial side cross-sectional view of the cap and the beverage container after capping.

FIG. 9 is a partial side cross-sectional view of the cap and the beverage container after capping according to a variation.

FIG. 10 is a partial side cross-sectional view of the cap and the beverage container after capping according to another variation.

### DESCRIPTION OF EMBODIMENTS

Hereinafter, an airtight container for beverage according to one embodiment of the present invention and a manufacturing method for the same will be described, with reference to the drawings.

### 1. Airtight Container

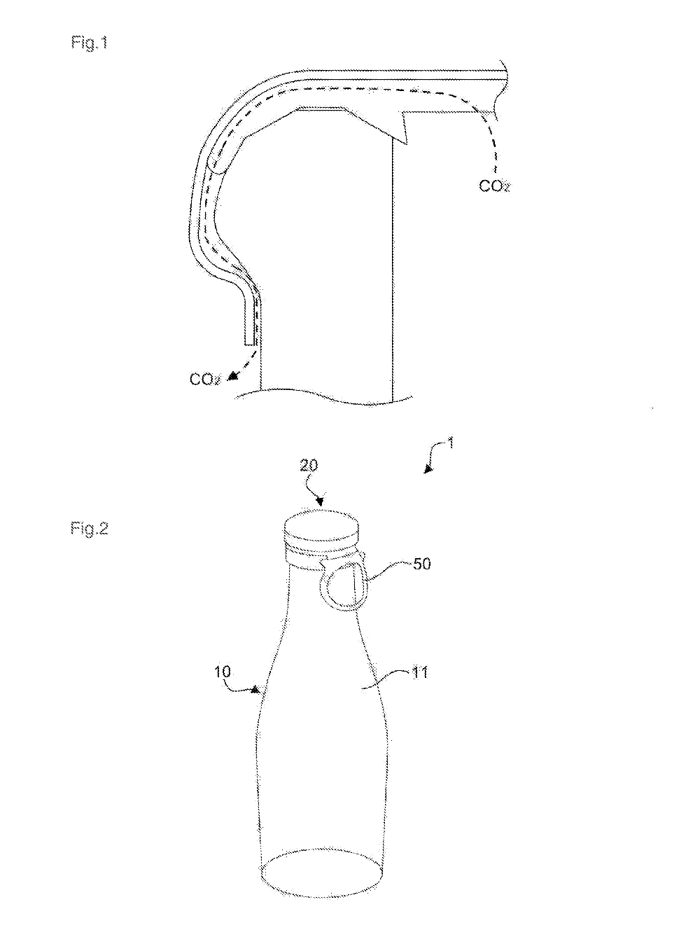

As shown in FIG. 2, an airtight container 1 according to this embodiment has a beverage container 10 that contains a beverage and a cap 20 that seals an orifice 16 (see FIG. 5) of an upper portion of the beverage container 10, and is designed such that high airtightness is maintained. Accordingly, the beverage that is enclosed within the airtight container 1 is typically envisioned to be a positive pressure beverage that includes a gas such as a carbonated beverage and a beverage that is enclosed together with an inert gas. The inert gas is enclosed for the purpose of antioxidation of the contents, improving the strength of the container or the like. Note that, unless otherwise stated, the up-down direction in the present embodiment is defined with the orifice 16 side being up and the bottom surface side being down, along an axis passing through the center of the bottom surface of the beverage container 10 and the center of the orifice 16. Also, a direction that is orthogonal to the up-down direction defined here is referred to as the lateral direction or the horizontal direction.

### 1-1. Beverage Container

The beverage container 10 according to the present embodiment is made of PET (polyethylene terephthalate). However, since resin materials including PET are generally gas permeable, coating and multilayering for enhancing the gas barrier performance are performed on the beverage container 10 in order to ensure airtightness. Since vinous well-known methods can be employed for this method a detailed description thereof is omitted here. Also, in the present embodiment, a resin material is preferably selected as the material of the beverage container from the viewpoint of qualities such as lightness.

As shown in FIGS. 2 and 5, the beverage container 10 has a bottomed cylindrical body portion 11 and an annular flange 12 that is continuous with an upper portion of the body portion 11. The circular orifice 16 for extracting the beverage is formed in an upper end portion of the body portion 11. That is, the flange 12 defines the periphery of the orifice 16. There is no step between an inner circumferential surface of the flange 12 and an inner circumferential surface of the body portion 11.

A side cross-sectional view of the flange 12 is shown in FIG. 5, and as shown in this diagram, on an upper surface 14 of the flange 12, a corner region (peripheral portion of the orifice 16) 14a located radially inward and a corner region 14b located radially outward are rounded. Also, a lower surface 15 of the flange 12 is rounded in a corner region 15a located radially outward, and the corner region 14b curves more gently than the corner region 15a.

Furthermore, a substantially horizontal surface 15b that is at an angle of 90 degrees or more to the outside surface of the body portion 11 is formed on the lower surface 15 of the flange 12. More specifically, an angle α (see FIG. 6) formed by the outside surface of the body portion 11 and the substantially horizontal surface 15b of the flange 12 is preferably around 92 degrees (90 to 95 degrees) in the present embodiment in which the beverage container 10 is made of PET. Note that if the beverage container 10 is made of glass, this angle is preferably around 140 degrees (135 to 145 degrees). Also, regardless of the material of the beverage container 10, generally the angle α is preferably 90 to 145 degrees, and more preferably 90 to 140 degrees. Note that, in the present embodiment, the upper surface of the flange 12 is a region that is visible when the flange 12 is viewed from directly above, and the lower surface 15 of the flange 12 is a region that is visible when the flange 12 is viewed from directly below. Also, a lateral surface 17 of the flange 12 is a region that is visible when the flange 12 is viewed laterally from the outer side. The corner region 14b is formed on an upper portion of the lateral surface 17, and the corner region 15a is formed on a lower portion of the lateral surface 17. As defined here, the lateral surface 17 of the flange 12 partially overlaps with the upper surface 14 and the lower surface 15.

### 1-2. Cap

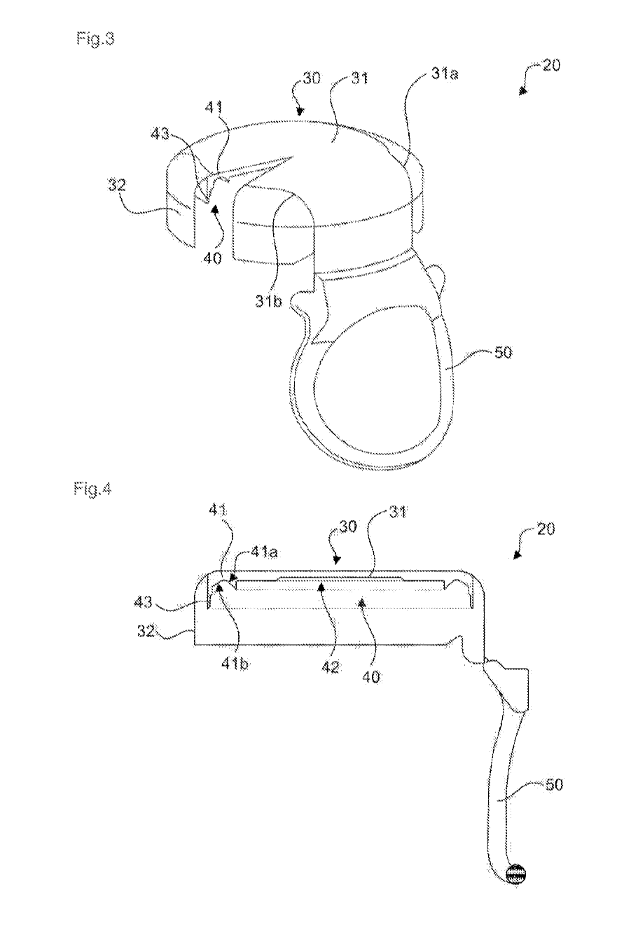

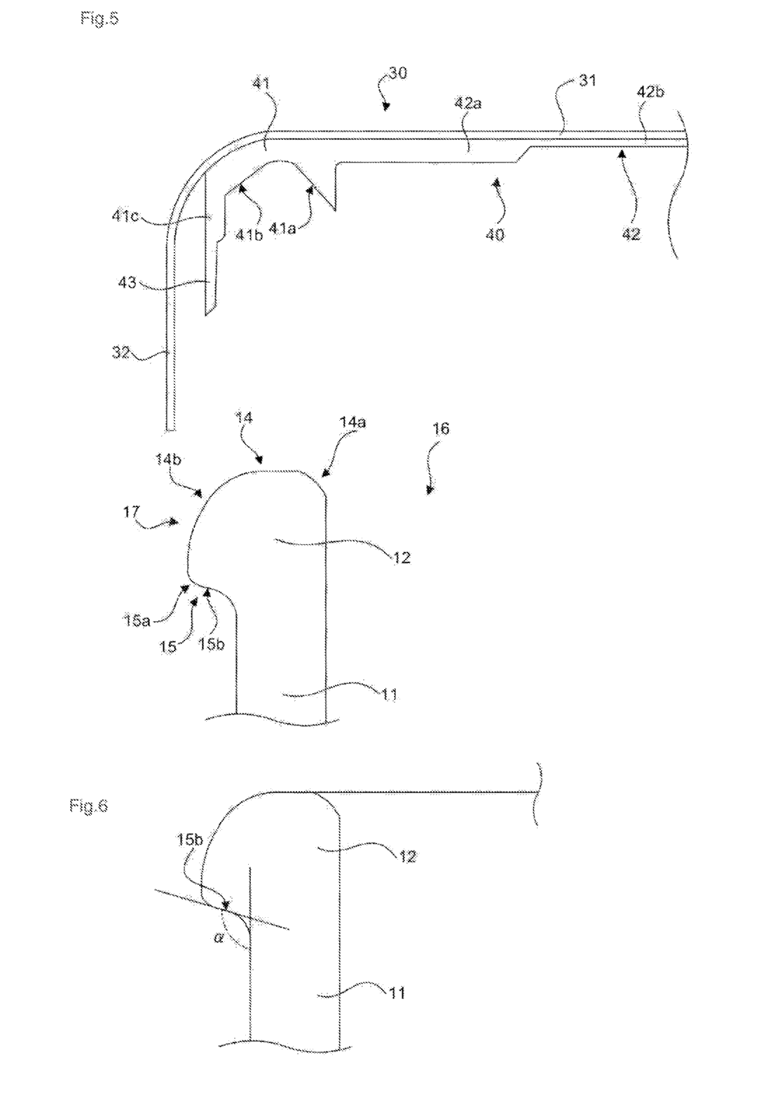

As shown in FIGS. 3 and 4, the cap 20 has an exterior body 30 a liner 40 that is installed on the inner side of the exterior body 30, and a ring tab 50 that is continuous with the exterior body 30. The exterior body 30 and the liner 40 are the members that works together to seal the orifice 16 of the beverage container 10. That is, the liner 40 directly covers the orifice 16 and the flange 12 of the beverage container 10, and the exterior body 30 covers the liner 40 from the outer side. Also, the ring tab 50 is a member for a user to hook a finger into, when removing the cap 20 from the beverage container 10. Note that, in FIG. 3, a portion (fan-shaped in planar view) of the exterior body 30 and the liner 40 is cut away to facilitate description.

In the present embodiment, the liner 40 is formed from an elastic material such as resin, and, more specifically, is a PE product. Accordingly, the Liner 40 has elasticity. As a result, the liner 40, by being pressed against the flange 12 of the beverage container 10, elastically deforms so as to conform to the outer shape of the flange 12, and, in particular at a thick outer circumferential portion 41 which will be discussed later, elastically deforms so as to conform to the outside shape of the flange 12 and to closely contact the flange 12 firmly. Accordingly, it is possible for the liner 40 to have pressure resistance and shock resistance, while effectively preventing liquid communication between the inside and outside of the airtight container 1. However, since the liner 40 is made of a resin, as mentioned above, gas barrier performance is low. Note that, in another embodiment, the liner 40 can also be made of another resin, such as PE, PP (polypropylene), PVC (polyvinyl chloride) and EVA (ethylene and acetic acid vinyl copolymerization resin), and can also be a material other than a resin.

On the other hand, in the present embodiment, the exterior body 30 is formed from a plastically deformable material having a higher gas barrier performance than the liner 40, and is more specifically made of aluminum Accordingly, the exterior body 30, at the time of a capping process of attaching the cap 20 to the beverage container 10, is securely fixed to the beverage container 10, while pressing the liner 40 firmly against the flange 12 of the beverage container 10, in a state of sandwiching the liner 40 between the exterior body 30 and the beverage container 10. At this time, the liner 40 on the inner side is entirely covered by the exterior body 30 so as to not be visible from the outer side. Also, the exterior body 30, which is made of a metal, has very high gas barrier performance, and is thereby able to effectively prevent gas communication between the inside and outside of the airtight container 1 via the liner 40.

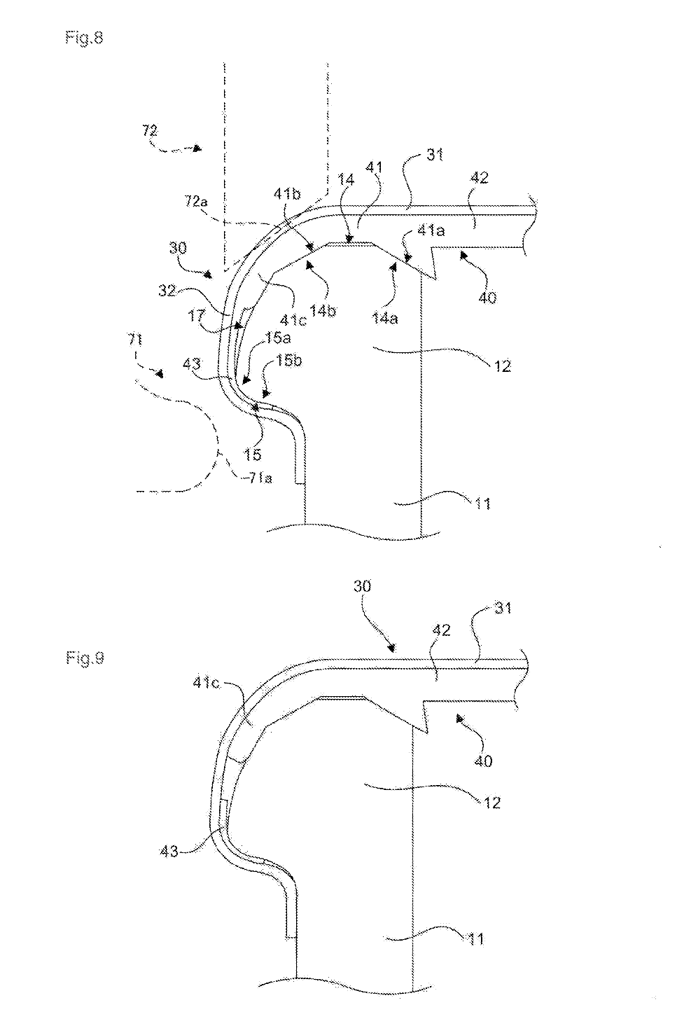

Hereinafter, configurations of the liner 40 and the exterior body 30 will be described in detail. First, configurations of the liner 40 and the exterior body 30 before capping will be described, with reference to FIGS. 4 and 5. The liner 40 before capping is provided with a disk portion 42 for covering the orifice 16 of the beverage container 10, and an annular outer circumferential portion 41 connected to an outer circumferential edge of the disk potion 42. An annular thin liner portion 43 that extends downward is continuous with a lower edge of the outer circumferential portion 41. This thin liner portion 43 is, as will be discussed later, long enough to reach to the lower surface 15 of the flange 12, when the cap 20 is installed on the beverage container 10 (see FIG. 8). An inward sloping surface 41a that slopes inwardly is formed on the lower surface of the outer circumferential portion 41 at a radially inward region, and an outward sloping surface 41b that slopes outwardly is formed on the lower surface of the outer circumferential portion 41 at a radially outward region. Also, an annular thick liner portion 41c is connected to an outer circumferential edge of the radially outward region and extends substantially vertically downward from the outer circumferential edge. At the time of capping, the inward sloping surface 41a closely contacts the corner portion 14a of the upper surface 14 of the flange 12, and the outward sloping surface 41b closely contacts the corner region 14b of the upper surface 14 of the flange 12. Also, at this time, the inner circumferential surface of the thick liner portion 41a closely contacts particularly an upper portion of the lateral surface 17 of the flange 12 (see FIG. 8). The outer circumferential portion 41 is thick compared with the thin liner portion 43. Also, the disk portion 42 is composed of a thicker annular region 42a on the outer side and a thinner disk-shaped portion 42b that is continuous on the inner side with this portion 42a.

A thickness t1 of the thin liner portion 43, although not particularly limited, is, for example, preferably 0.15 to 0.3 mm, and more preferably 0.2 to 0.25 mm, from the viewpoint of narrowing the gas passage, which will be discussed later. On the other hand, since liquid tightness, pressure resistance, shock resistance and the like are required, the thick liner portion 41c needs to have a certain thickness, in order to provide enough elasticity to meet these requirements. As a result, a ratio of the thickness t1 of the thin liner portion 43 to a thickness t2 of the thick liner portion 41c (thickness t1 of thin liner portion/thickness t2 of thick liner portion) is, for example, preferably 0.25 to 0.8, and more preferably 0.4 to 0.5. Note that the thick liner portion 41c in the present embodiment is a part of the outer circumferential portion 41 that is located directly upward of the thin liner portion 43 and is connected to the outer circumferential edge of the radially outward region of the outer circumferential portion 41, and covers particularly the upper portion of the lateral surface 17 of the flange 12. Also, the thick liner portion 41c does not necessarily have a constant thickness, and may, for example, be formed so as to become thinner in a direction approaching the thin liner portion 43. On the other hand, the thin liner portion 43 does not necessarily have a constant thickness, and may, for example, be formed so as to become thinner in a direction away from the thick liner portion 41c. In this case, the average thicknesses of the thin liner portion 43 and the thick liner portion 41c can be called t1 and t2.

On the other hand, the exterior body 30 before capping has a disk-like upper surface portion 31 and an annular sidewall portion 32 extending downward from an outer circumferential edge of the upper surface portion 31, and covers the liner 40 from the outer side. A boundary portion between the upper surface portion 31 and the sidewall portion 32 curves in an arc in cross-sectional view. The annular sidewall portion 32 extending downward from the outer circumferential edge of the upper surface portion 31 extends downward of the thin liner portion 43 of the liner 40. More specifically, it is possible, by a capping process discussed later, for the sidewall portion 32 to press the thin liner portion 43 against the lower portion of the lateral surface 17 of the flange 12 and bring the thin liner portion 43 in close contact therewith, and extends further downward than the thin liner portion 43 to an extent that the entire liner 40 is confined within a space that is formed between the exterior body 30 and the beverage container 10. The thin liner portion 43 is merely covered, and is not fixed to the inner circumferential surface within the sidewall portion 12.

Next, the ring tab 50 will be described. As shown in FIG. 3, two line-like scores 31a and 31b are formed in the exterior body 30. The scores 31a and 31b extend slightly on the inner side of the outer circumferential edge of the upper surface portion 31 in planar view of the exterior body 30 and roughly parallel to this outer circumferential edge. Although both end portions of the scores 31a and 31b on the near side in FIG. 3 reach the lower edge of the sidewall portion 32, neither end portions on the far side in FIG. 3 reach the lower end of the sidewall portion 32. Also, the ring tab 50 connected to the exterior body 30 is positioned between the end portions of the scores 31a and 31b on the near side. Note that the ring tab 50 according to the present embodiment is made of a resin such as PE (polyethylene).

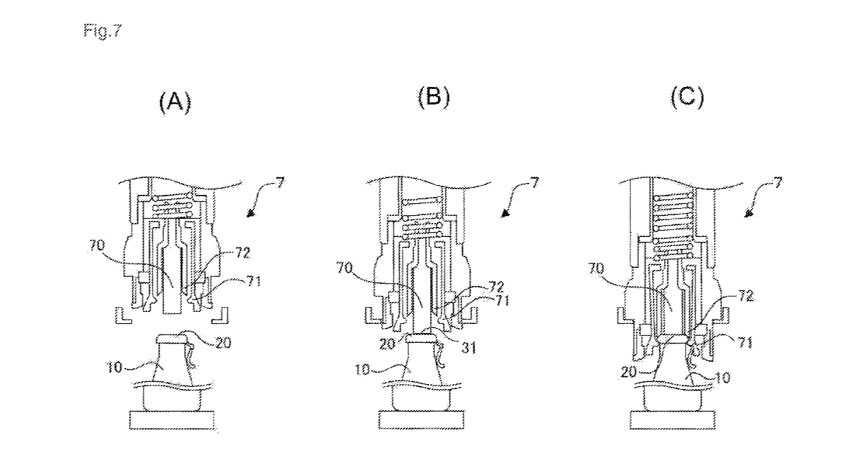

Next, configurations of the liner 40 and the exterior body 30 after capping will be described while describing the capping process, with reference to FIGS. 7 and 8. In the capping process, the beverage container 10 filled with a beverage is first conveyed to below a capping apparatus 7 by a conveyor or the like (see FIG. 7(A)). At this time, the cap 20 before capping is placed on the mouth portion of the beverage container 10 in a state of being positioned roughly horizontally. Next, in this state, a columnar inner plunger 70 of the capping apparatus 7 drops down, contacts the upper surface portion 31 of the exterior body 30, and presses the upper surface portion 31 downward (see FIG. 7(B)). The outer circumferential portion 41 of the liner 40 thereby elastically deforms, as a result of which the inward sloping surface 41a of the outer circumferential portion 41 closely contacts the corner portion 14a of the upper surface 14 of the flange 12, and the outward sloping surface 41b closely contacts the corner region 14b of the upper surface 14 of the flange 12. The outer circumferential portion 41 thereby covers the upper surface 14 of the flange 12, the orifice 16 of the beverage container 10 is closed, and a liquid portion of the beverage within the container beverage 10 is sealed from the outside.

Next, a pressure plunger 72 of the capping apparatus 7 moves to the height position shown with a broken line in FIG. 8, in a state where the above pressing state by the inner plunger 70 is maintained. Also, from there a lateral sealing sleeve 71 moves radially inward while moving downward (see FIG. 7(C)). As a result, the sidewall portion 32 of the exterior body 30 and the thin liner portion 43 of the liner 40 are firmly pressed against the lower surface 15 of the flange 12 and the body portion 11 by a tip 71a of the lateral sealing sleeve 71. Also, at the same time, the vicinity of the boundary between the upper surface portion 31 and the sidewall portion 32 of the exterior body 30 and the outward sloping surface 41b of the outer circumferential portion 41 of the liner 40 are firmly pressed against the corner region 14b of the flange 12 by the tip 72a of the pressure plunger 72. At this time, the inner circumferential surface of the thick liner portion 41c is also firmly pressed against particularly the upper portion of the lateral surface 17 of the flange 12. Note that the tip 71a of the lateral sealing sleeve 71 has a semicircular shape whose apex faces radially inward in side cross-sectional view.

As shown in FIG. 8, the exterior body 30 plastically deforms so as to conform to the upper surface 14, the lateral surface 17 and the lower surface 15 of the flange 12, due to the pressing of the sealing sleeve 71 and the pressure plunger 72. Also, following this, the sidewall portion 32 of the exterior body 30 presses the thin liner portion 43 against the vicinity of the corner region 15a including the substantially horizontal surface 15b of the flange 12 and brings the thin liner portion 43 in close contact therewith. As a result, the thin liner portion 43 is sandwiched between the sidewall portion 32 and the flange 12 and elastically deforms. More specifically, the thin liner portion 43 curves to conform to these surfaces 17 and 15 so as to cover the lateral surface 17 and the lower surface 15 of the flange 12 in the vicinity of the corner region 15a. Also, at this time, the entire liner 40 is confined within the space that is formed between the exterior body 30 and the beverage container 10. That is, the thin liner portion 43 extends to the lower surface 15 along the flange 12, and the sidewall portion 32 of the exterior body is fixed to the beverage container 10 in a state of extending further downward than and covering the thin liner portion. Note that the vicinity of the corner region 15a is a region where the gap between the exterior body 30 and the beverage container 10 is narrowest, and, as a result, in the present embodiment, the narrowest gap between the exterior body 30 and the beverage container 10 is filled with the liner 40. That is, the leakage of gas via the gap between the exterior body 30 and the beverage container 10 can be efficiently prevented.

The above-mentioned crimping operation is performed at a fixed interval around the entire circumference of the cap 20, as a result of which the lower end portion of the exterior body 30 after capping will have a wavy outer circumferential surface. When the crimping on the entire circumference of the cap 20 ends, the inner plunger 70, the sealing sleeve 71 and the pressure plunger 72 retract to the positions shown in FIG. 7(A), and thereby the capping process on one airtight container 1 ends. Then, the next beverage container 10 and cap 20 are conveyed to below the inner plunger 70, and a similar process is repeated.

In the airtight container 1 that has passed through the above process, the liner 40 will be in a state of being pressed against the flange 12 by the exterior body 30 from above at the outer circumferential portion 41 and from below at the thin liner portion, as a result of which the cap 20 will be securely fixed to the beverage container 10. Also, the cap 20 will be further firmly fixed to the beverage container 10, as a result of the liner 40 catching on the corner region 15a of the lower surface 15 of the flange 12. Furthermore, the pressure of the gas contained in the beverage container 10 produces a force that pushes the cap 20 up from the orifice 16. This force can be resisted as a result of the liner 40 catching on the lower surface 15 of the flange 12, and enables the cap 20 to be fixed to the flange 12. Also, due to the cap 20 being pushed up from the orifice 16 by the pressure of the gas, the exterior body 30 and the thin liner portion 43 are brought in close contact by the corner region 15a of the flange 12, and the airtightness of the airtight container 1 is enhanced. Furthermore, in order for the gas within the beverage container 10 to leak out through the liner 40, the gas must pass the thin liner portion 43, but here the gas passage is narrowed at the thin liner portion 43. Accordingly, gas communication between the inside and outside of the beverage container 10 via the resin liner 40 is suppressed, and the airtightness of the airtight container 1 is enhanced.

Next, a method of using the beverage container 10 manufactured in the above manner will be described. First, when a user pulls the ring tab 50 up at the time of opening the airtight container 1, the exterior body 30 is torn along the scores 31a and 31b. At this time, the exterior body 30 does not separate into three parts, since the end portions of the scores 31a and 31b on the far side in FIG. 3 do not reach the outer edge. As a result, the upward force that the user applies to the ring tab 50 is conveyed to the liner 40 via the exterior body 30, and the cap 20 is removed from the mouth portion of the beverage container 10 due to the members 30 and 40 both deforming (includes plastic deformation and elastic deformation. Therefore, the airtight container 1 can be easily opened without needing a special implement. Also, since the exterior body 30 is torn at the time of opening, the airtight container 1 cannot be resealed, and thus malicious behavior such as the mixing of a foreign substance in the beverage after opening the airtight container 1 is effectively prevented.

### 2. Features

The cap 20 according to the above embodiment has the liner 40 and the exterior body 30, and the liner 40 is provided with the disk portion 42 and the annular outer circumferential portion 41 connected to the outer circumferential edge of the disk portion 42. Also, the outer circumferential portion 41 has the radially inward region, the radially outward region, and the thick liner portion 41c. At the time of sealing the beverage container 10, the inward sloping surface 41a of the radially inward region closely contacts the corner portion 14a of the flange 12, the outward sloping surface 41b of the radially outward region closely contacts the corner region 14b of the flange 12, and the inner circumferential surface of the thick liner portion 41c closely contacts the upper portion of the lateral surface 17. That is, since the liner 40 is able to exhibit sufficient elastic force at the radially inward region and the radially outward region of the outer circumferential portion 41, the liner 40 closely contacts the upper portion of the lateral surface 17 of the flange 12 firmly at the thick liner portion 41c, and the orifice 16 of the beverage container 10 is liquid tightly sealed. Also, the thick liner portion 41c has pressure resistance and shock resistance. Furthermore, in the above embodiment, in addition to the above features, the liner 40 has the thin liner portion 43. This thin liner portion 43 is pressed against the lower portion (corner region 15a) of the lateral surface 17 of the flange 12 by the exterior body 30. That is, since the gas passage is narrowed at the thin liner portion 43, gas communication between the inside and outside of the beverage container 10 via the resin liner 40 can be suppressed. Accordingly, here, the airtightness of the airtight container 1 can be improved.

### 3. Variations

Although one embodiment of the present invention has been described above, the present invention is not limited to the above embodiment, and various modifications that do not depart from the spirit of the invention can be made. For example, the following modifications can be made. Also, the features of the following exemplary modifications can be combined as appropriate.

3-1

The exterior body 30 is not limited to being made of a metal. In order, however, to serve the function of preventing gas communication between the inside and outside of the airtight container 1 via the liner 40, a material having a higher gas barrier performance than the liner 40 is preferable, and the use of a barrier resin, for example, as the exterior body 30 is conceivable.

3-2

As shown in FIG. 9, the outer circumferential portion 41 and the thin liner portion 43 of the liner 40 do not need to be shaped so as to be continuous. In this case, however, the thin liner portion 43 in particular is preferably bonded to the exterior body 30 by a suitable method, so as to not drop out from the exterior body 30.

3-3

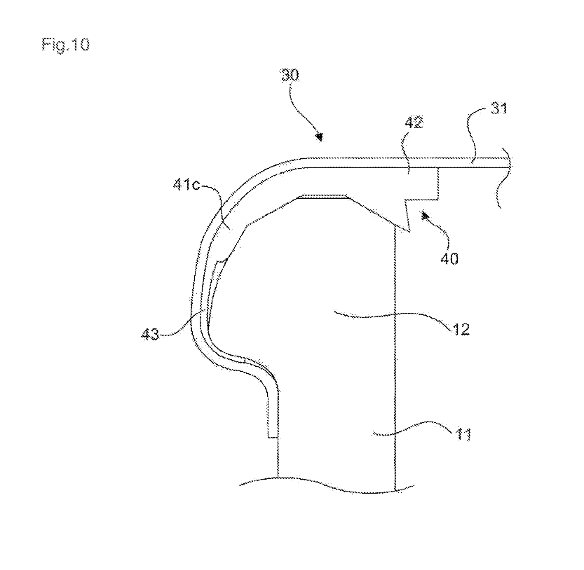

As shown in FIG. 10, a configuration may be adopted in which the disk portion 42 of the liner 40 is at least partially cut, and the lower surface of the upper surface portion 31 of the exterior body 30 is partially exposed to the interior space of the beverage container 10.

3-4

In the above embodiment, a step was formed on the radially inner side at the boundary between the thick liner portion 41c and the thin liner portion 43, but the thick liner portion 41c and the thin liner portion 43 may be formed continuously so as to describe a smooth line, without forming such a step. On the other hand, a step may be formed on the radially outer side at the boundary between the thick liner portion 41c and the thin liner portion 43.

### REFERENCE SIGNS LIST

1 Airtight container

10 Beverage container

11 Body portion

12 Flange

14b Corner region (upper side portion of flange)

15a corner region (lower side portion of flange)

15b Substantially horizontal surface

16 Orifice

20 Cap

30 Exterior body

40 Liner

41 Outer circumferential portion

41a Inward sloping surface

41b Out aid sloping surface

41c Thick liner portion

43 Thin liner portion

1-6. (canceled)

7. An airtight container for positive pressure beverage, comprising a beverage container having a body portion and a flange that is continuous with an upper portion of the body portion and defines an orifice, and a cap that is attached to the beverage container so as to seal the orifice,
wherein the cap has:
a liner that has a thin liner portion for sealing a lower side portion of the flange and a thick liner portion for sealing an upper side portion of the flange; and
an exterior body that is fixed to the flange so as to cover the liner from an outer side, in order to seal the orifice together with the liner, and
the exterior body presses the thin liner portion against the lower side portion of the flange and brings the thin liner portion in close contact therewith.

8. The airtight container for positive pressure beverage according to claim 7, wherein a rounded corner region is formed on the lower side portion of the flange.

9. The airtight container for positive pressure beverage according to claim 7, wherein the exterior body extends further downward than the liner, to an extent that an entirety of the liner is confinable within a space formed between the exterior body and the beverage container.

10. The airtight container for positive pressure beverage according to claim 8, wherein the exterior body extends further downward than the liner, to an extent that an entirety of the liner is confinable within a space formed between the exterior body and the beverage container.

11. The airtight container for positive pressure beverage according to claim 7, wherein the liner is made of a resin.

12. The airtight container for positive pressure beverage according to claim 8, wherein the liner is made of a resin.

13. The airtight container for positive pressure beverage according to claim 9, wherein the liner is made of a resin.

14. The airtight container for positive pressure beverage according to claim 10, wherein the liner is made of a resin.

15. The airtight container for positive pressure beverage according to claim 1, wherein the exterior body is made of a plastically deformable metal.

16. The airtight container for positive pressure beverage according to claim 8, wherein the exterior body is made of a plastically deformable metal.

17. The airtight container for positive pressure beverage according to claim 9, wherein the exterior body is made of a plastically deformable metal.

18. The airtight container for positive pressure beverage according to claim 10, wherein the exterior body is made of a plastically deformable metal.

19. The airtight container for positive pressure beverage according to claim rein the exterior body is made of a plastically deformable metal.

20. The airtight container for positive pressure beverage according to claim 12, wherein the exterior body is made of a plastically deformable metal.

21. The airtight container for positive pressure beverage according to claim 13, wherein the exterior body is made of a plastically deformable metal.

22. The airtight container for positive pressure beverage according to claim 14, wherein the exterior body is made of a plastically deformable metal.

23. A manufacturing method of an airtight container for positive pressure beverage, comprising the steps of:
preparing a beverage container having a body portion and a flange that is continuous with an upper portion of the body portion and defines an orifice;
preparing a cap having a liner that has a thin liner portion for sealing a lower side portion of the flange and a thick liner portion for sealing an upper side portion of the flange, and having an exterior body that is to be fixed to the flange so as to cover the liner from an outer side, in order to seal the orifice together with the liner;
filling the beverage container with the positive pressure beverage; and
fixing the cap to the beverage container, such that the thin liner portion is pressed against and brought in close contact with the lower side portion of the flange, after the beverage container has been filled with the positive pressure beverage.
